(19) United States
(12) Patent Application Publication
(10) Pub. No.: US 2025/0096571 A1
(43) Pub. Date: Mar. 20, 2025

(54) APPARATUS, SYSTEM AND METHOD OF AC AND DC V2X AND SMART CHARGING USING A BIDIRECTIONAL ELECTRIC VEHICLE SUPPLY EQUIPMENT

(71) Applicant: EATON INTELLIGENT POWER LIMITED, DUBLIN 4 (IE)

(72) Inventors: Ahmed A. Mohamed, Arvada, CO (US); Vijay Bhavaraju, Arvada, CO (US); Daniel A. Sanchez, Denver, CO (US); Santino Fiorello Graziani, Aliquippa, PA (US); Sandy Omar Jimenez Gonzalez, Coraopolis, PA (US)

(73) Assignee: EATON INTELLIGENT POWER LIMITED, DUBLIN 4 (IE)

(21) Appl. No.: 18/884,389

(22) Filed: Sep. 13, 2024

Related U.S. Application Data
(60) Provisional application No. 63/538,358, filed on Sep. 14, 2023.

(51) Int. Cl. H02J 3/32; B60L 53/62; B60L 53/63; B60L 53/66; B60L 55/00; H02J 3/00

(52) U.S. Cl. CPC H02J 3/322; B60L 53/62; B60L 53/63; B60L 53/66; B60L 55/00; H02J 3/001; H02J 3/0073

(57) ABSTRACT

A bidirectional electric vehicle supply equipment (EVSE) for use in a power distribution system having an EV, an electric grid, a control panel and an aggregator or grid operator. The bidirectional EVSE includes a voltage sensor structured to sense grid voltage and EV voltage; an EVSE smart circuit breaker coupled to the voltage sensor and structured to connect or disconnect the EV based on a signal from the voltage sensor and to disable a PWM signal before opening EVSE contactors, an EVSE backup control power structured to provide control power to the bidirectional EVSE when the electric grid is not available; and a bidirectional EVSE communications controller structured to communicate with the EV, the control panel and the aggregator during selecting an operation mode, transitioning to a selected operation mode, and performing operation and oversight protection in the selected operation mode.

### CROSS REFERENCE TO RELATED APPLICATIONS

The application claims priority to U.S. Provisional Patent Application No. 63/538,358 filed on Sep. 14, 2023, entitled “Apparatus, System and Method of AC and DC V2X and Smart Charging Using a Bidirectional Electric Vehicle Supply Equipment,” which is incorporated herein by reference in its entirety.

### FIELD OF THE INVENTION

The disclosed concept relates generally to an apparatus, system and method of supplying power in an electrical network, and in particular an apparatus, system and method of AC and DC V2X and smart charging electrical vehicles using a bidirectional AC or DC apparatus generally described as electric vehicle supply equipment.

### BACKGROUND OF THE INVENTION

Electric vehicles' (EVs) primary focus is on reducing greenhouse gas emissions. Nevertheless, the energy storage (e.g., a battery) on the EV can be enabled for many other applications by using a bidirectional charging system with a smart inverter (on- or off-board). EVs with smart inverters can act as mobile battery energy storage units and provide power for end user application. The technology of using the EV as mobile battery energy storage units is known as Vehicle-to-Everything (V2X) technology (also referred to as V2X for short hereinafter). V2X includes numerous use cases such as Vehicle-to-Buildings (V2B), Vehicle-to-Homes (V2H), Vehicle-to-Load (V2L), Vehicle-to-Microgrid (V2M) and Vehicle-to-Grid (V2G). V2H, V2B, V2L and V2M services enable an EV to provide an emergency backup power at homes, buildings and microgrids to support loads fully or partially during a power outage as well as normal operation. Such an EV also can be integrated with other distributed energy resources (DERs) such as photovoltaic (PV) solar and/or stationary battery energy storage to form a stable and sustainable microgrid to keep more loads on for longer periods. This has the potential to bring additional values to EV owners by leveraging the large battery in their EVs to replace backup combustion generators and/or home battery storage.

Based on charging equipment and EV capability, there can be two approaches for V2X: an AC V2X and a DC V2X. In the AC V2X, an EV includes an onboard smart inverter with grid-forming (forming a grid when the utility is disconnected) and grid-following (following the grid when the utility is connected) capabilities to support bidirectional AC power-flow between the EV and the loads. The AC V2X allows lower upfront costs to the end users (e.g., homeowners) and is appropriate for residential charging. Residential charging includes mostly AC Level 1 and Level 2 and requires low power (e.g., <20 kW) since the EVs are connected to an EV charger (e.g., an electric vehicle supply equipment (EVSE)) for longer periods than high-power applications. However, because the smart inverter is onboard and mobile, it is complex to communicate, control and ensure safety of the EV, the EVSE, the loads and other devices connected thereto in the AC V2X. In the DC V2X, an off-board stationary smart inverter is built within the EVSE, which can supply and receive DC power to and from the EV battery (bidirectional DC). Therefore, in the DC V2X the EV does not need an on-board smart inverter, and thus it is easier to certify an EV for V2X applications than in the AC V2X. However, DC chargers are expensive and better suited for high-powered charging stations than the residential charging. However, in either approach the EVs remain invisible to the electric grids and loads, leaving islanding, reconnection and/or communications among the devices inefficient, haphazard, and dangerous. For example, such uncoordinated islanding and/or reconnection may result in situations in which both the electric grid and the EVs are generating voltage that are not synchronized, creating significant safety hazards.

There is room for improvement in a V2X technology.

There is a need for an improved interface between the EVs and the grid and/or the loads in a V2X technology.

### SUMMARY OF THE INVENTION

These needs, and others, are met by embodiments of the disclosed concept in which a bidirectional electric vehicle supply equipment (EVSE) for use in a power distribution system is provided. The power distribution system includes an electric grid, an aggregator, a control panel, an electric vehicle (EV) coupled to a smart inverter, and loads. The bidirectional EVSE is structured to be coupled to the EV, the aggregator and the loads via the load center and includes: a voltage sensor structured to sense grid voltage and EV voltage; an EVSE smart circuit breaker coupled to the voltage sensor, connect or disconnect the EV based on a signal from the voltage sensor and interrupt current flowing to the loads, the EV and/or the electric grid in an event of fault; an EVSE backup control power structured to provide control power to the bidirectional EVSE when the electric grid is not available or power from EV is not available; and a bidirectional EVSE communications controller structured to communicate with the EV, the control panel and the aggregator during selecting an operation mode, transitioning to a selected operation mode and performing the selected operation mode.

Another embodiment provides an electric grid, an electric vehicle (EV), a plurality of loads, a control panel connected to the electric grid and including a grid smart circuit breaker structured to connect and disconnect the electric grid from the loads, an EV smart circuit breaker structured to connect and disconnect the EV from the loads and/or the electric grid, and load smart circuit breakers structured to connect and disconnect the loads from the electric grid and/or the EV; and a bidirectional EVSE including: a voltage sensor structured to sense grid voltage and EV voltage; an EVSE smart circuit breaker coupled to the voltage sensor, connect or disconnect the EV based on a signal from the voltage sensor and interrupt current flowing to the loads, the EV and/or the electric grid in an event of fault; an EVSE backup control power structured to provide control power to the bidirectional EVSE when the electric grid is not available or power from EV is not available; a bidirectional EVSE communications controller structured to communicate with the EV, the control panel and the aggregator during selecting an operation mode, transitioning to a selected operation mode and performing the selected operation mode, and an aggregator communicatively coupled to the bidirectional EVSE and structured to monitor and manage the operations of at least the EV and the bidirectional EVSE.

Yet another embodiment provides a method of providing power to loads in a power distribution system including an electric grid, an aggregator, a control panel, an electric vehicle (EV) coupled to a smart inverter, and loads. The method includes providing a bidirectional EV supply equipment (EVSE) structured to be coupled to the EV via an EV connector and the loads via the load center, the bidirectional EVSE comprising (i) a voltage sensor structured to sense grid voltage and EV voltage; (ii) an EVSE smart circuit breaker coupled to the voltage sensor, connect or disconnect the EV based on a signal from the voltage sensor and interrupt current flowing to the loads, the EV and/or the electric grid in an event of fault; (iii) an EVSE backup control power structured to provide backup control power to the bidirectional EVSE when the electric grid is not available or power from EV is not available; and (iv) a bidirectional EVSE communications controller structured to communicate with the EV, the control panel and the aggregator during selecting an operation mode, transitioning to a selected operation mode and performing the selected operation mode. The method further includes determining that an EV is connected to the bidirectional EVSE; determining that the electric grid is not available based on the determination that the EV is connected to the bidirectional EVSE; selecting an operation mode based on the determination that the electric grid is not available; transitioning to a selected operation mode; and performing the selected operation mode.

### BRIEF DESCRIPTION OF THE DRAWINGS

A full understanding of the invention can be gained from the following description of the preferred embodiments when read in conjunction with the accompanying drawings in which:

FIG. 1 is a diagram of an exemplary power distribution system using an AC V2X technology in accordance with an example embodiment of the disclosed concept;

FIG. 2 is a diagram of an exemplary power distribution system using a DC V2X technology in accordance with an example embodiment of the disclosed concept;

FIG. 3 is a partial block diagram of a diagram of the power distribution system of FIG. 1 using a bidirectional EVSE including a bidirectional EVSE communications controller in accordance with an example embodiment of the disclosed concept;

FIG. 4 is a partial block diagram of a diagram of the power distribution system using a bidirectional EVSE including a bidirectional EVSE communications controller in accordance with an example embodiment of the disclosed concept;

FIGS. 5A-D illustrate a flow chart for a method of providing power in the power distribution system using the bidirectional EVSE including the bidirectional EVSE communications controller of the FIGS. 1 and 3 in accordance with an example embodiment of the disclosed concept in accordance with an example embodiment of the disclosed concept;

FIGS. 6A-G illustrate a flow chart for a method of providing power the power distribution system using the bidirectional EVSE including the bidirectional EVSE communications controller of the FIGS. 1 and 3 in accordance with an example embodiment of the disclosed concept in accordance with an example embodiment of the disclosed concept; and

FIGS. 7A-B illustrate pulse width modulation (PWM) handshaking procedures defined for a V2H mode and a V2G mode, respectively, in accordance with an example embodiment of the disclosed concept.

### DETAILED DESCRIPTION OF THE INVENTION

Directional phrases used herein, such as, for example, left, right, front, back, top, bottom and derivatives thereof, relate to the orientation of the elements shown in the drawings and are not limiting upon the claims unless expressly recited therein.

As employed herein, the statement that two or more parts are “coupled” together shall mean that the parts are joined together either directly or joined through one or more intermediate parts.

The example embodiments of the disclosed concepts provide a bidirectional electric vehicle supply equipment (EVSE) for EVs. It advantageously enables an EV battery in conjunction with a bi-directional on or off-board charger to act as a backup supply to support home loads (V2H), home microgrid (V2M), and feed power to the electric grid (V2G). It allows and manages the bi-directional power flow using novel PWM handshaking procedures with an onboard or offboard smart inverter, the PWM handshaking procedures being specifically tailored for each operation mode (e.g., without limitation, the V2G mode, the V2H mode, and the charging mode) as well as a novel bidirectional voltage awareness capability that allows detecting line voltages from both the electric grid side and the EV side and manages the safety of the EV hardware and the loads. It also provides adjustable oversight protections including, e.g., without limitation, overvoltage protection, undervoltage protection, overcurrent protection, over-frequency protection and under-frequency protection with adjustable settings for threshold and tripping time and mechanisms for each operation mode. It can be adjusted and/or configured to protect an offboard smart inverter or an onboard smart inverter (also referred to as an onboard charger (OBC) and/or other components therein. The adjustable oversight protections are provided in addition to the built-in protections of the onboard or offboard smart inverter. It also provides power quality functions that monitor the supply voltage and current waveforms and allow tripping if the supply voltage and current violate power quality thresholds including harmonics, voltage quality, frequency quality and so forth. It supports the control panels (e.g., without limitation, load centers) with islanding a home or building. It provides an interlocking capability that prevents two voltage source supplies to be paralleled during a V2H mode or a V2G mode. These functions and capabilities of the inventive bidirectional EVSE allows for V2X charging and discharging by the EV, which the existing EVSEs do not provide as they are limited to providing only simple charging.

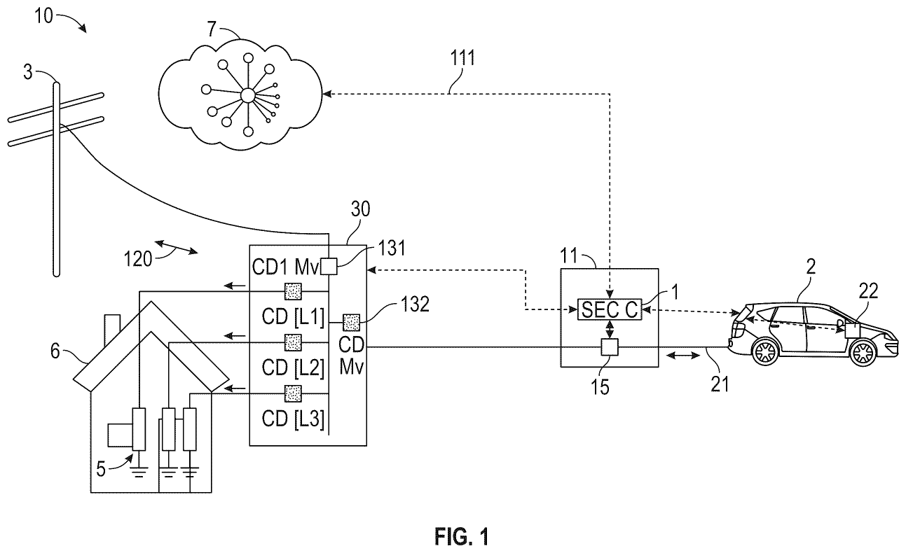

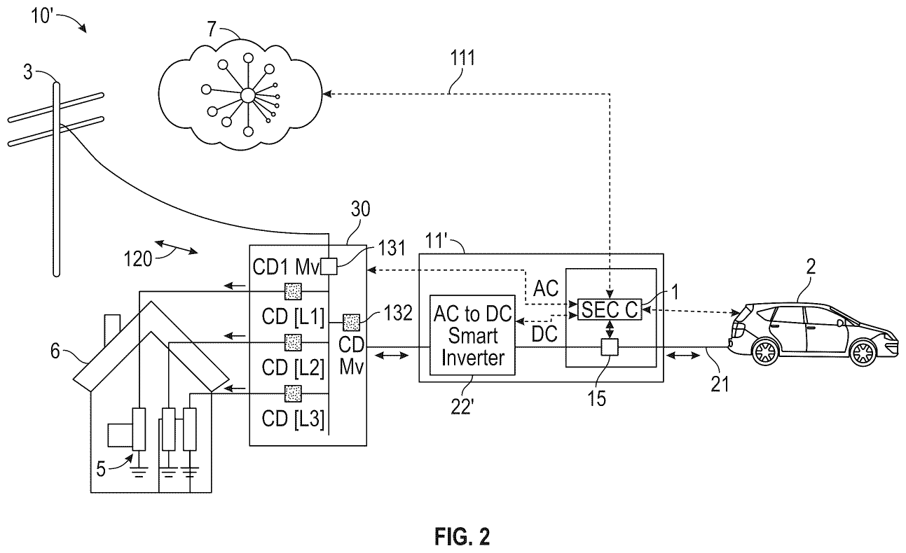

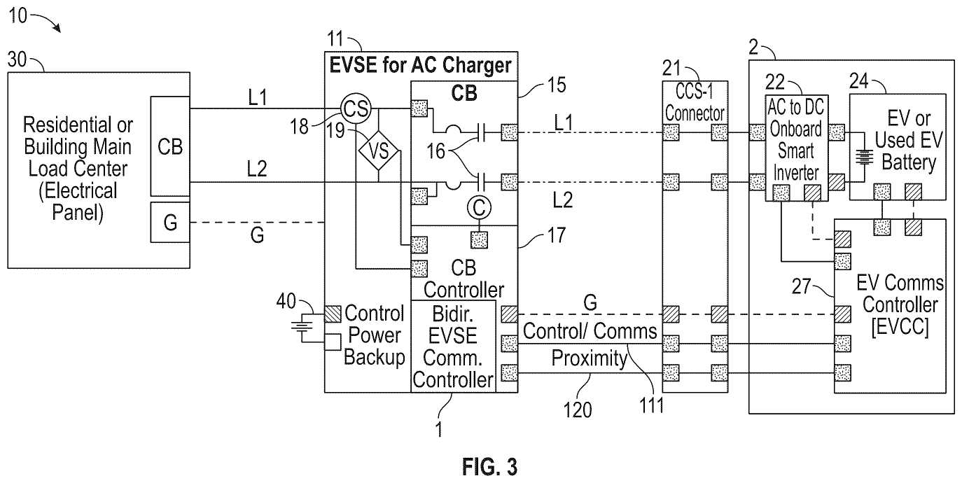

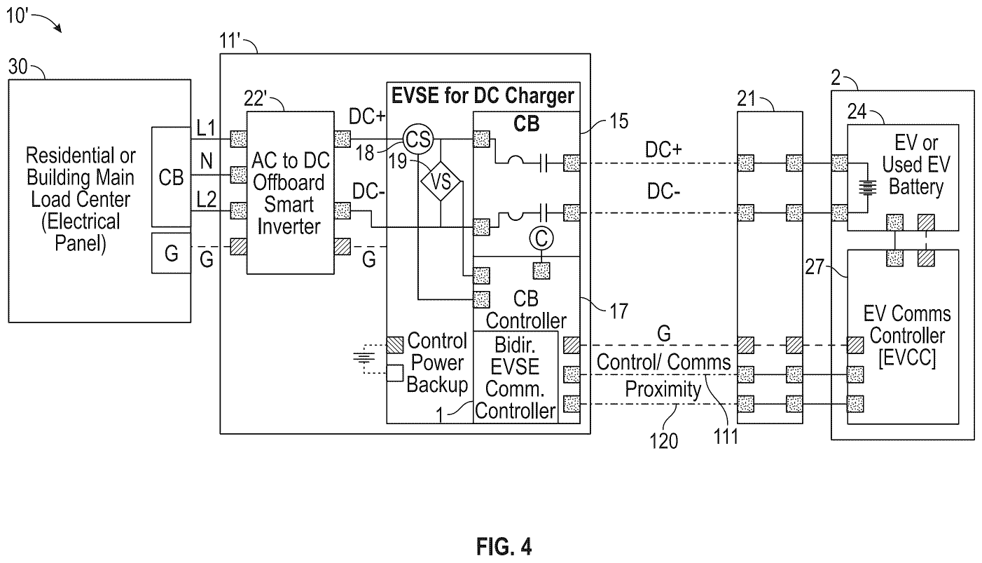

FIG. 1 is a diagram of an exemplary power distribution system 10 using an AC V2X technology via a bidirectional EVSE 11 having a bidirectional EVSE communications controller 1 coupled to an on-board smart inverter 22 in accordance with an example embodiment of the disclosed concept. FIG. 2 is a diagram of an exemplary power distribution system 10′ using a DC V2X technology via a bidirectional EVSE 11′ having a bidirectional EVSE communications controller 1 coupled to an off-board smart inverter 22′ in accordance with an example embodiment of the disclosed concept. FIG. 3 is a partial block diagram of the exemplary power distribution system 10 of FIG. 1. FIG. 4 is a partial block diagram of the exemplary power distribution system 11′ of FIG. 2. The example bidirectional EVSE 11, 11′ and the directional EVSE communications controller 1 therein and operations thereof are described with reference to FIGS. 1-4. It is noted that in high-power application, the smart inverter 22′ for the DC V2X technology may be disposed external to the bidirectional EVSE 11′. Unless otherwise specifically provided, the descriptions of the bidirectional EVSE 11, the power distribution system 10 and any components thereof apply to both the AC V2X charging/discharging including an on-board smart inverter 22 and the DC V2X charging/discharging including an off-board smart inverter 22′.

The power distribution system 10 includes a bidirectional EVSE 11 having a bidirectional EVSE communications controller 1, an EV 2, an electric grid 3, a plurality of loads 5, a load center 30 and an aggregator 7. The electric grid 3 may be a utility grid, providing AC power to the loads 5 and/or the EV 2. The EV 2 is structured to be coupled to the bidirectional EVSE 11 via an EV connector 21 for charging. The EV 2 includes an on-board AC to DC smart inverter 22, an EV battery 24 and an EV communications controller (EVCC) 27. The voltage from the EV battery 24 can be supplied to the loads 5 as secondary power source via the smart inverter 22 and the bidirectional EVSE 11. The EVCC 27 is structured to communicate with the bidirectional EVSE communications controller 1 during selecting an operation mode, transitioning to a selected operation mode, and performing the selected operation mode. It further communicates with the bidirectional EVSE communications controller 1 associated with a PWM handshaking procedure for the selected operation mode and provides state of charge management for the battery 24. The EVCC 27 may be, for example and without limitation, a microprocessor, a microcontroller, or some other suitable processing device or circuitry. It may also include a memory which may include a software, firmware, set of instruction to perform the communications operations of the EV 2. The plurality of loads 5 are coupled to the load center 30 via the power lines (L1, L2, N) and may be included in a facility 6 such as a home, a building or other structures. The load center 30 may be a control panel at a home 6 or a building (not shown) and includes a plurality of smart circuit breakers structured to trip the current flowing to the loads 5 in an event of a fault. The plurality of smart circuit breakers include a grid smart circuit breaker 131 structured to connect and disconnect the electric grid 3 from the loads and/or the EV 2, an EV smart circuit breaker 132 structured to connect and disconnect the EV 2 from the loads 5 and/or the electric grid 3, and a plurality of load smart circuit breakers structured to connect and disconnect the loads 5 from the electric grid 3 and/or the EV 2. An aggregator 7 is a utility cloud server structured to monitor and manage the operations of the EV 2, the smart inverter 22, and the EVSE 11. It may be a grid operator. The aggregator 7 typically is used for distributed energy resources (DERs) such as the solar PVs and batteries, but the inventive bidirectional EVSE communications controller 1 allows the aggregator 7 to treat the EV 2 as a DER and enables the aggregator 7 to manage the EV 2 in, e.g., without limitation, the V2G mode.

The smart inverter 22 converts DC output of the EV 2 into AC so as to provide power to the loads 5 as a secondary power source. The bidirectional EVSE 11 then allows the power to flow in and out of the EV 2. It enables bidirectional power supply between the electric grid 3 and the EV 2 as shown by the bidirectional arrow 120. While FIGS. 1 and 3 show an on-board AC smart inverter 22 disposed within the EV 2, the smart inverter 22 may be an off-board DC smart inverter 22′ integrated within the bidirectional EVSE 11′. As such, the bidirectional EVSE 11, 11′ and the bidirectional EVSE communications controller 1, 1′ advantageously work with an on-board AC smart inverter 22 and an off-board DC smart inverter 22′ in similar manners as described herein.

In general, a power distribution or operation mode includes an islanded mode and a grid-connected mode. In an islanded mode, the electric grid 3 is disconnected or unavailable due, e.g., without limitation, a power outage, and the EV 2 provides power to the loads 5 as a voltage source. In a grid-connected mode, the electric grid 3 is connected or reconnected to the load panel 30 and provides power to the loads 5 and/or the EV 2. In the grid-connected mode, the EV 2 assumes a grid-following mode for V2G. In an islanded mode, the EV 2 assumes a grid-forming mode for V2H. Types of the grid-following mode include, e.g., without limitation, an EV-charging (V1G) mode and an EV-to-grid discharging (V2G) mode. In the V1G mode, the EV 2 charges itself from the electric grid 3 and in the V2G mode, the EV 2 discharges power from its battery into the electric grid 3. Types of the grid-forming mode include, e.g., without limitation, an EV-to-home (V2H) mode, an EV-to-building (V2B) mode and an EV-to-microgrid (V2M) mode. In the V2H mode, the EV 2 supplies power to the loads 5 connected to a home 6 as a secondary power source. In the V2B mode, the EV 2 supplies power to the loads 5 connected to a building as a secondary power source. In the V2M mode, the EV 2 forms a microgrid with other distributed energy resources (not shown) available in the power distribution system 10 and the microgrid supplies power to the loads 5 as a secondary power source. The bidirectional EVSE 11 and the bidirectional EVSE communications controller 1 allow selecting an operation mode using the V2X technology, transitioning to the selected operation mode and performing the selected operation mode and ensure such selection, transition and performance to take place in a safe and efficient manner unlike the conventional EVSEs that are unable to support the V2X technology.

The existing EVSEs provide only one mode of operation: charging an EV with power received from the electric grid. As such, they do not provide any capability to select a different mode of operation such as a V2G mode or a V2H mode. Hence, it is neither bidirectional nor capable of selecting, transitioning to or performing different operation modes. For example, when a power outage occurs, the conventional EVSEs open immediately, disconnecting the EV from the power distribution system. As such, the conventional EVSEs simply does not allow the EV to perform V2G or V2H even if the EV is V2X capable. Further, since it provides only one operation mode, it provides only one handshaking procedure. For example, a conventional EVSE with a Type 2 connector uses control pilot (CP) line to communicate for charging an EV. When the EV is not connected to the EVSE, the CP line has 12V. When the EV is connected to the EVSE, the CP line voltage drops to 9V, indicating to the EVSE that the EV is connected to the EVSE for charging. The EVSE then generates a PWM signal producing a square wave switching at 1 kHz at 9V. However, such one handshaking procedure for the V1G mode only cannot be used for the V2H mode nor the V2G mode. The inventive bidirectional EVSE communications controller 1, however, not only allows the smart inverter 22 to select, transition to and perform more than only the V1G mode, but also ensures that selection, transition and performance of different operation modes occur in a safe and efficient manner by providing communications control, power quality control, and/or associated device protections.

The bidirectional EVSE 11 is structured to be coupled to the EV 2 via the EV connector 21 and the loads 5 via the smart circuit breakers in the load center 30. The bidirectional EVSE 11 includes a voltage sensor 19, an EVSE smart circuit breaker 15, an EVSE backup control power 40, and the bidirectional EVSE communications controller 1. The bidirectional EVSE 11 is further structured to provide protections including overvoltage protection, undervoltage protection, overcurrent protection, over frequency protection and/or under frequency protection; provide ride-through functions including overvoltage ride-through, undervoltage ride-through, over-frequency ride-through, under-frequency ride-through and/or phase change ride-through; provide and control mode selection, transition and performance; meter and monitor power quality parameters including voltage, current, frequency, power, energy and reactive power; provide interlocks in the grid-forming mode; support islanding and loss of the grid voltage; and provide bidirectional voltage awareness. Further, it provides a unique tripping mechanism during the protection events (e.g., without limitation, overcurrent, overvoltage, undercurrent, undervoltage, fault events) by stopping PWM signal first, then opening the contactor. Stopping PWM forces the EV to stop/reduce current flow, so the contactor will open under near zero current, which is safer and better for the device health/life. That is, it provides a safe transition mechanism during a protection event or while transitioning from one mode to another.

In some examples, the bidirectional EVSE 11 may include measurement devices to measure the input (charging/absorbing) and output (discharging/supplying) of the EV power (Watts) and reactive power (VARs), voltage, frequency to monitor EV operations for grid and residential safety purposes. In some examples, the bidirectional EVSE 11 is compatible for charging a standard EV that does not support bidirectional charge/discharge functions. In some examples, the bidirectional EVSE 11 includes a logging component structured to record, when an EV connects and attempts to seek authorization to discharge, any EVSE modifications associated with the permission to discharge, and/or timestamps for charging/discharging activities. The bidirectional EVSE 11 may make such logging components available to a user (e.g., without limitation, an operator) via a user interface or other devices or methods. In some examples, the bidirectional EVSE 11 supports negotiation with the EV 2 for charging and discharging based on requests from the utility, tariff or based on needs of an EV operator.

In the bidirectional EVSE 11′ including or connected to an off-board smarter inverter, the bidirectional EVSE 11′ provides an EV and off-board smart inverter interface for using the DC port on the EV 2. That is, when the bidirectional EVSE 11′ is connected to a DC port, the EV 2 should be enabled through the same communication line in which the DC port is active. That is, when the DC port is enabled, the bidirectional EVSE 11′ is able to detect that the DC port is enabled and measure the DC voltage from the EV battery 24. By providing the EV and off-board smart inverter interface, the bidirectional EVSE 11 can satisfy the DC port connectivity requirements. It also provides an off-board DC smart inverter V2G and G2V management and off-board DC bidirectional smart inverter V2H and H2V power management.

The EVSE smart circuit breaker 15 includes or is connected to the voltage sensor 19 structured to sense the grid voltage and the EV voltage. It further includes a current sensor 18 structured to sense the line current and a controller 17 coupled to the sensors 18, 19 and structured to control the operation of the EVSE smart circuit breaker 15, including, e.g., without limitation, receiving signals from the current sensor 18 and the voltage sensor 19 and closing or opening the contactors 16 based on the signals. The EVSE smart circuit breaker 15 is further structured to disable a PWM signal before opening the EVSE contactors 16 in order to allow the smart inverter 22 to stop the operation, and thus limit the tripping current. Further, the EVSE smart circuit breaker 15 is further structured to allow the bidirectional EVSE 11 to disconnect the EV 2 from local electric power systems based on a recommendation by the aggregator 7, the utility or a controller, or to prevent EV discharging if the EV 2 does not comply with authentication and authorization requirements from the utility or any other appropriate entities or if the EV 2 exceeds the configuration and management settings and/or ranges.

The EVSE backup control power 40 may be, e.g., a 120V source, a UPS, a battery bank and is structured to provide control power to the bidirectional EVSE 11 when the electric grid 3 is not connected (e.g., without limitation, due to a power outage). That is, during a power outage the EVSE backup control power 40 provides power to the bidirectional EVSE 11 such that it can close the EVSE smart circuit breaker 15 as well as manage communications between the smart inverter 22 and the EV 2. In addition, the EVSE backup control power 40 assists in providing the voltage awareness by the voltage sensor 19 when the electric grid 3 is not available or disconnected from the load panel 30. A conventional EVSE only senses voltage from one direction, i.e., the electric grid 3 since it opens upon losing the electric grid 3. Thus, when the electric grid 3 is not available or disconnected, the conventional EVSE cannot detect any voltage from the EV or any other distributed energy resources. On the other hand, the bidirectional EVSE 11 has the bidirectional voltage awareness capability at all times and is aware of whether the line voltage is being provided by the electric grid 3 or the EV 2, and thus operates accordingly. For example, during a power outage, the bidirectional EVSE 11 remains active using the power from the EVSE backup control power 40 and closes the smart circuit breaker 15, which then allows the EV voltage to be detected by the voltage sensor 19. This is important in that it allows the bidirectional EVSE 11 to remain operational and be aware that the electric grid 3 is no longer available, and thus transmit to the smart inverter 22 a signal indicating that the smart inverter 22 can generate and provide the voltage from the EV battery 24. Hence, the EVSE smart circuit breaker 15 can detect the EV voltage. Further, by closing the contactors 16, it also allows the EV smart circuit breaker 132 in the load panel 30 to know that there is voltage from the EV 2. In addition, the EVSE control backup power 40 is structured to provide an independent control power supply that supports ride-through during all events including, e.g., without limitation, undervoltage, overvoltage, under-frequency, over-frequency situations.

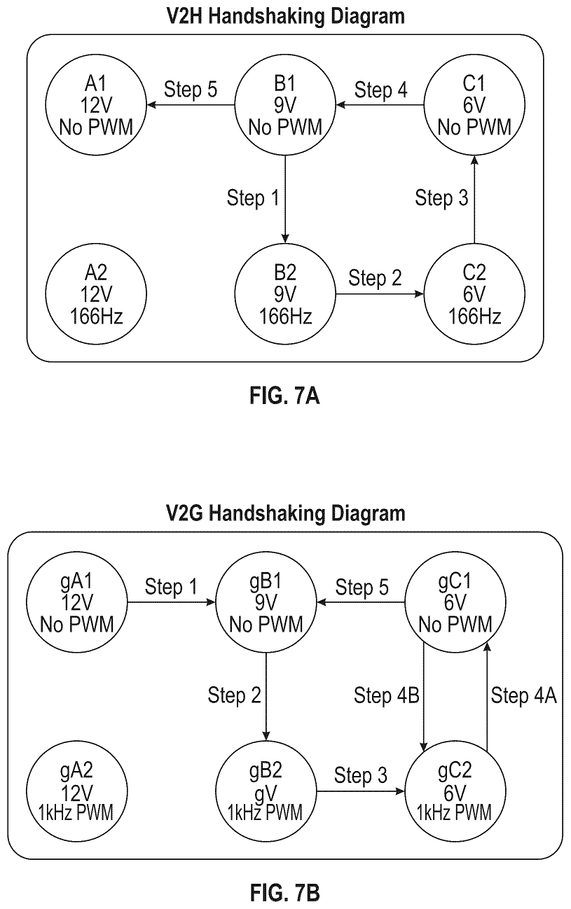

The bidirectional EVSE communications controller 1 is communicatively coupled to an EV communications controller (EVCC) 27, the aggregator 7 and the load center 30 and structured to communicate with the EV 2 via the EVCC 27 through the standard charging cable using, e.g., without limitations SAE J3072, IEEE2030.5, ISO15118, the aggregator 7 via a wireless connection 111 using, e.g., without limitation, OCPP or IEEE2030.5 protocols, load center 30 via a wireless or wired connection, e.g., without limitation, OCPP or IEEE2030.5 protocols. It is further structured to provide communications control during mode selecting, transitioning to a selected mode and performing the selected mode. For example, it is structured to communicate digital data bidirectionally with the EV and the backend device including, e.g., without limitation, a controller, energy management system, home energy management system, building energy management system, load center 30, smart islanding component, aggregator 7 and/or the utility server. The digital information may include proximity information of the EV 2 via the proximity line 120. It is further structured to provide a novel PWM handshaking procedure defined for each operation mode. For example, the bidirectional EVSE communications controller 1 is structured to verify a change in the operation mode and then change the PWM frequency based on the new operation mode. The PWM handshaking procedures include, e.g., without limitation, a V2H handshaking procedure and a V2G handshaking procedure as shown in FIGS. 7A-B. The bidirectional EVSE communications controller 1 may be, for example and without limitation, a microprocessor, a microcontroller, or some other suitable processing device or circuitry. The memory, which can be any of one or more of a variety of types of internal and/or external storage media such as, without limitation, RAM, ROM, EPROM(s), EEPROM(s), FLASH, and the like that provide a storage register, i.e., a machine readable medium, for data storage such as in the fashion of an internal storage area of a computer, and can be volatile memory or nonvolatile memory. The memory may include a software, firmware, set of instruction to communicate with the EV 2, backend devices (e.g., without limitation, the electric grid 3 and the loads 5), the aggregator 7, user interfaces, the utility, or other controller) cloud in the power distribution system 10.

The V2H PWM handshaking procedure includes six states and five steps as shown in FIG. 7A. Six states include a first state (also referred to as “B1”) having a first CP voltage (e.g., without limitation, 9V) and no PWM signal, a second state (also referred to as “B2”) having the first CP voltage and a first PWM signal (e.g., without limitation, 166 Hz), a third state (also referred to as “C2”) having a second CP voltage (e.g., without limitation, 6V) and the first PWM signal, a fourth state (also referred to as “C1”) having the second CP voltage and no PWM signal, a fifth state (also referred to as “A1”) having a third CP voltage (e.g., without limitation, 12V) and no PWM signal, and a sixth state (also referred to as “A2”) having the third CP voltage and no PWM signal. The five steps includes a first step changing from the first state to the second state, a second step changing from the second state to the third state, a third step changing from the third state to the fourth state, a fourth step changing from the fourth state to the first state, and a fifth step changing from the first state to the fifth state.

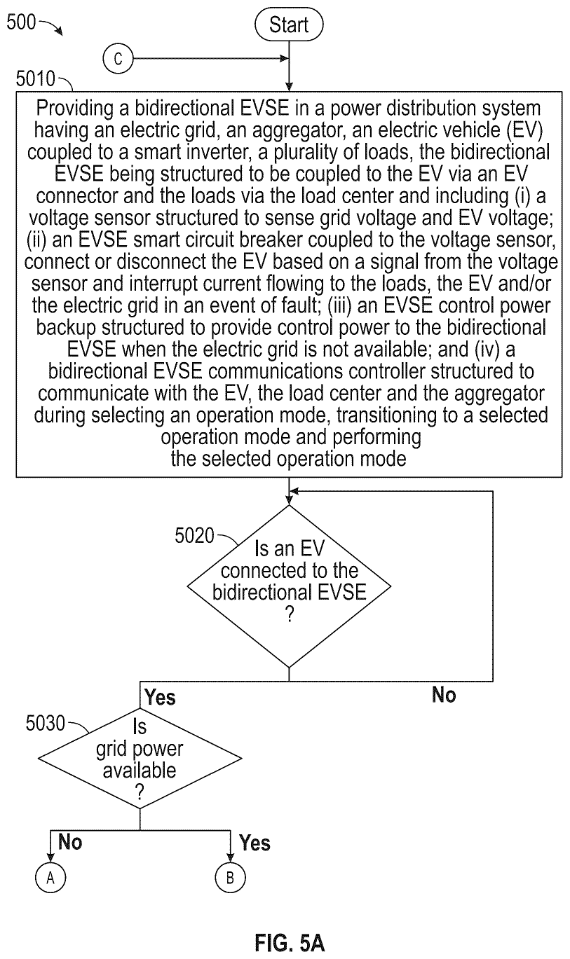

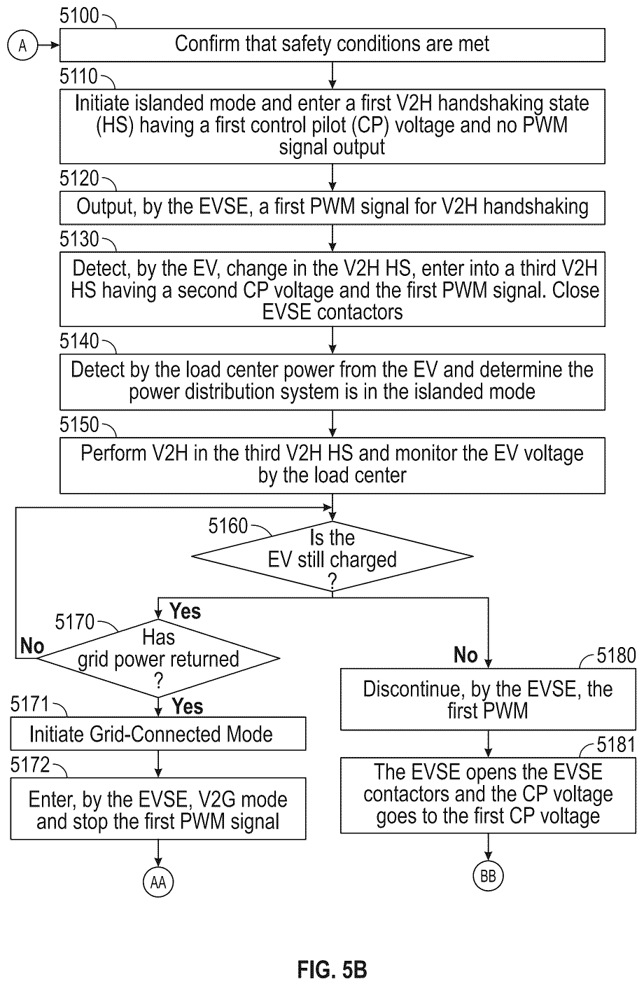

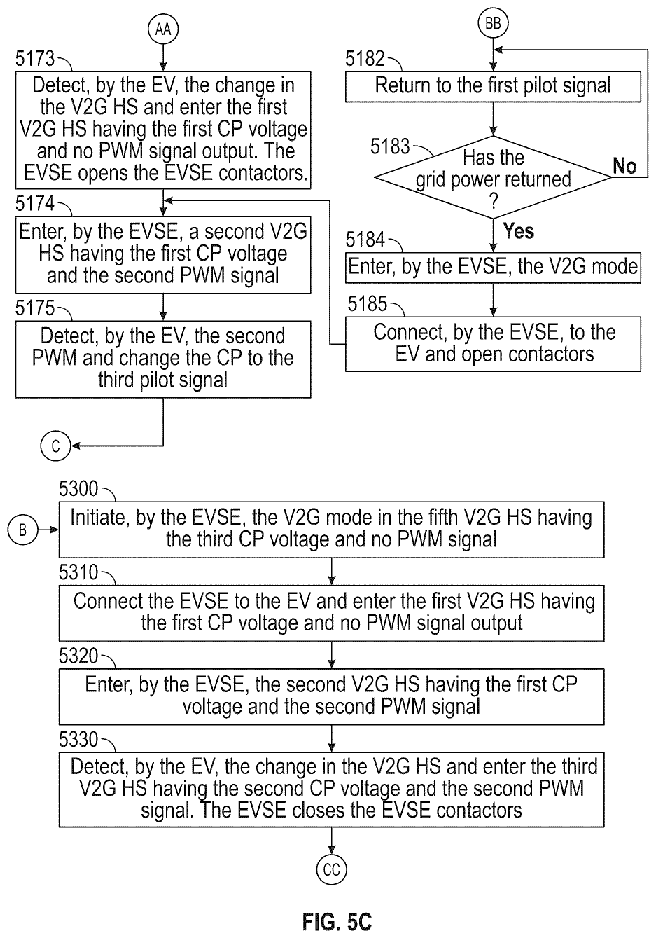

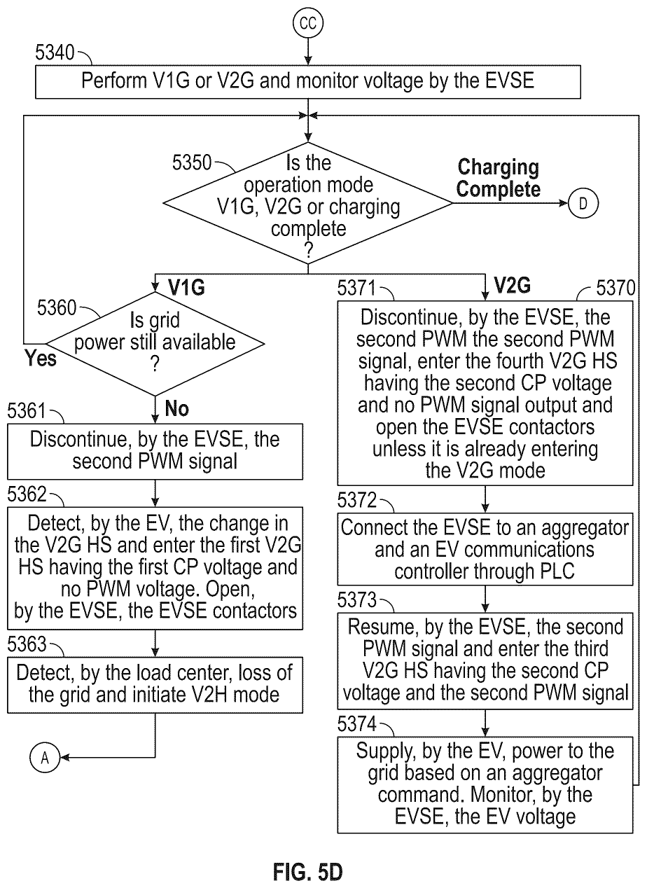

The PWM V2G handshaking procedure includes six states and five steps as shown in FIG. 7B. Six states include a first state (also referred to as “gB1”) having the first CP voltage and no PWM signal, a second state (also referred to as “gB2”) having the first CP voltage and a second PWM signal (e.g., without limitation, 1 kHz), a third state (also referred to as “gC2”) having the second CP voltage and the first PWM signal, a fourth state (also referred to as “gC1”) having the second CP voltage and no PWM signal, a fifth state (also referred to as “gA2”) having the third CP voltage and no PWM signal, and a sixth state (also referred to as “gA2”) having the third CP voltage and the second PWM signal. The five steps includes a first step changing from the fifth state to the first state, a second step changing from the first state to the second state, a third step changing from the second state to the third state, a fourth step changing from the third state to the fourth state, a fifth step changing from the fourth state to the third state and a sixth step changing from the fourth state to the first state. The execution of these handshaking procedures is discussed further in detail with reference to FIGS. 5A-D and 6A-G.

FIGS. 5A-D illustrate a flow chart for a method 5000 of selecting, transitioning and performing an operation mode (e.g., without limitation, V1G, V2G, or V2H) using the bidirectional EVSE 11 with an on-board smart inverter 22 in accordance with a non-limiting, example embodiment of the disclosed concept. The method 5000 may be performed by the bidirectional EVSE 11, the power distribution system 10 and any components thereof. In the V2H mode, the voltage is monitored by the load center 30. In the V2G mode, the voltage is monitored by the bidirectional EVSE 11. While FIGS. 5A-D illustrate AC V2X technology using an AC on-board smart inverter, similar method applies to DC V2X technology using a DC off-board smart inverter.

At 5010, a bidirectional EVSE is provided in a power distribution system having an electric grid, loads, a load center coupled to the electric grid and the loads, an EV coupled to a smart inverter and an aggregator structured to monitor and control power quality parameters of the electric grid and the EV. The bidirectional EVSE is structured to be coupled to the EV via an EV connector and the loads via the load center and includes a voltage sensor structured to sense grid voltage and EV voltage; an EVSE smart circuit breaker coupled to the voltage sensor, connect or disconnect the EV based on a signal from the voltage sensor and interrupt current flowing to the loads, the EV and/or the electric grid in an event of fault; an EVSE backup control power structured to provide control power to the bidirectional EVSE when the electric grid is not available; and a bidirectional EVSE communications controller structured to communicate with the EV, the load center and the aggregator during selecting an operation mode, transitioning to a selected operation mode and performing the selected operation mode.

At 5020, the bidirectional EVSE determines if grid power is available. If no, the method 5000 proceeds to 5100 for selecting, transitioning to and performing the V2H mode. If yes, the method 5000 proceeds to 5300 for selecting, transitioning to and performing the V2G mode.

At 5100, the bidirectional EVSE confirms that the safety conditions are met. For example, the electric grid is disconnected as well as the loads from the load center.

At 5110, the bidirectional EVSE initiates islanded mode and enters a first V2H handshaking state having a first control pilot (CP) voltage and no PWM signal output.

At 5120, the bidirectional EVSE outputs a first PWM signal for the V2H handshaking.

At 5130, the EV detects change of the V2H handshaking state and enters a third V2H handshaking state having a second CP voltage and the first PWM signal. The bidirectional EVSE closes the EVSE contactors.

At 5140, the load center detects power and determines that the power distribution system is in the islanded mode.

At 5150, the EV performs V2H in the third V2H handshaking state and the load center monitors the EV voltage.

At 5160, the bidirectional EVSE determines if the EV is still charged. If yes, the method 5000 proceeds to 5170. If not, the method 5000 proceeds to 5180.

At 5170, the bidirectional EVSE determines if the grid power has returned. If not, the method 5000 returns to 5160. If yes, the method proceeds to 5171. At 5171, the bidirectional EVSE initiates grid-connected mode. At 5172, the bidirectional EVSE enters the V2G mode and stops the first PWM signal. The bidirectional EVSE is in the fourth V2H handshaking state with the second CP voltage and no PWM signal output. At 5173, the EV detects the change in the V2H handshaking state and enters the second V2G handshaking state having the first CP voltage and no PWM signal output. At 5174, the bidirectional EVSE enters the second V2G handshaking state having the first CP voltage and the first PWM signa. At 5175, the EV detects the change in the V2G handshaking state and enters the third V2G handshaking state having the second CP voltage and the second PWM signal. The bidirectional EVSE closes the EVSE contactors. The method 5000 then returns to 5010.

At 5180, the bidirectional EVSE discontinues the first PWM signal and enters a fourth V2H HS having the second CP voltage and no PWM signal output. At 5182, the EVSE CP line returns to a third CP voltage and the bidirectional EVSE enters the fifth V2H HS. At 5183, the bidirectional EVSE determines if the grid power has returned. If no, the method 5000 returns to 5182. If yes, the method 5000 proceeds to 5184 at which the bidirectional EVSE initiates the V2G mode in the first V2G HS having the first CP voltage and no PWM signal. At 5185, the bidirectional EVSE connects to the EV and enters the first V2G HS having the first CP voltage and no PWM signal. The EVSE opens the EVSE contactors and the method 5000 then proceeds to 5174.

At 5300, the bidirectional EVSE initiates the V2G mode. It is in the fifth V2G handshaking state having the second CP voltage and no PWM signal.

At 5310, the bidirectional EVSE connects to the EV and enters the first V2G handshaking state having the third CP voltage and no PWM signal. The bidirectional EVSE opens the EVSE contactors.

At 5320, the bidirectional EVSE enters the second V2G handshaking state having the first CP voltage and the second PWM signal.

At 5330, the EV detects the change in the V2G handshaking state and enters the third V2G handshaking state having the second CP voltage and the second PWM signal. The bidirectional EVSE closes the EVSE contactors.

At 5340, the bidirectional EVSE is in the V2G mode and outputs the second PWM signal. It is in the third V2G handshaking state having the second CP voltage and the second PWM signal. The bidirectional EVSE monitors the EV voltage.

At 5350, the bidirectional EVSE determines if the EV is in charging mode (V1G) or V2G mode or has completed charging. If it has completed charging, the method 5000 returns to 5010. If in the V1G mode, the method 5000 proceeds to 5360. If in the V2G mode, the method 5000 proceeds to 5370.

At 5360, the bidirectional EVSE determines if the grid power is still available. If yes, the method 5000 returns to 5350. If no, the method 5000 proceeds to 5361 at which the bidirectional EVSE discontinues the second PWM signal and enters the fourth V2G handshaking state having the second CP voltage and no PWM signal output. At 5362, the EV detects the change in the V2G handshaking state and enters the first V2G handshaking state having the first CP voltage and no PWM voltage. The bidirectional EVSE opens the EVSE contactors. At 5363, the load center detects loss of the electric grid and begins the transition to the V2H mode and the method 5000 returns to 5100.

At 5370, the bidirectional EVSE discontinues the second PWM signal, enters the fourth V2G handshaking state having the second CP voltage and no PWM signal output, and opens the EVSE contactors unless it is already entering the V2G mode. At 5371, the bidirectional EVSE connects to the aggregator and the EV communication controller through the wireless connection (the PLC). At 5372, the bidirectional EVSE resumes outputting the second PWM signal and enters the third V2G handshaking state having the second CP voltage and the second PWM signal. The bidirectional EVSE closes the EVSE contactors. At 5373, the EV begins to supply power based on aggregator commands and the bidirectional EVSE monitors the EV voltage. The method 5000 then returns to 5350.

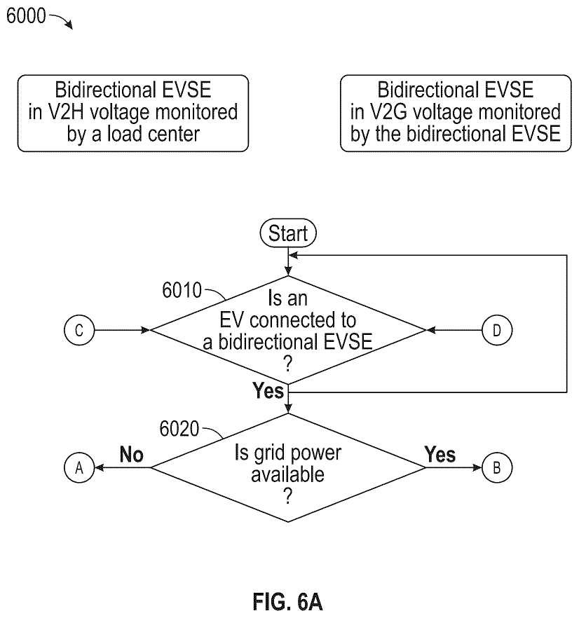

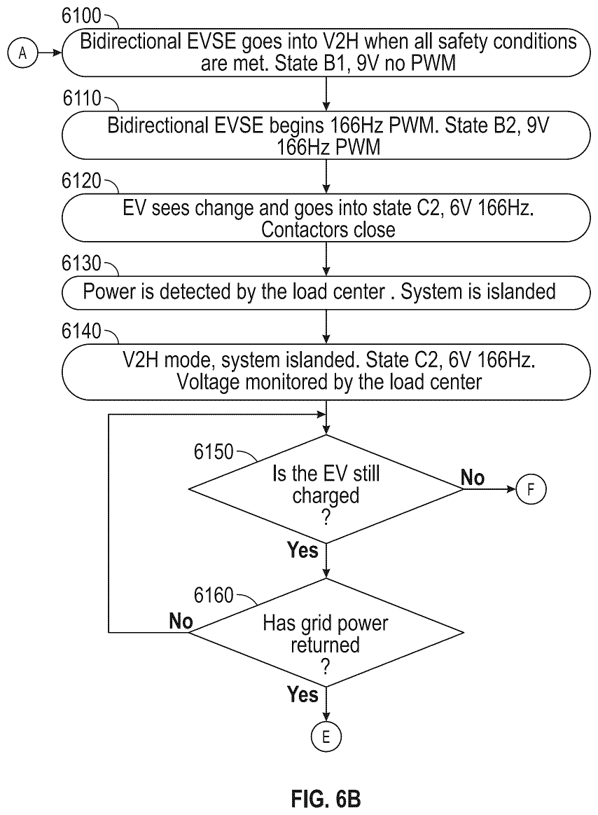

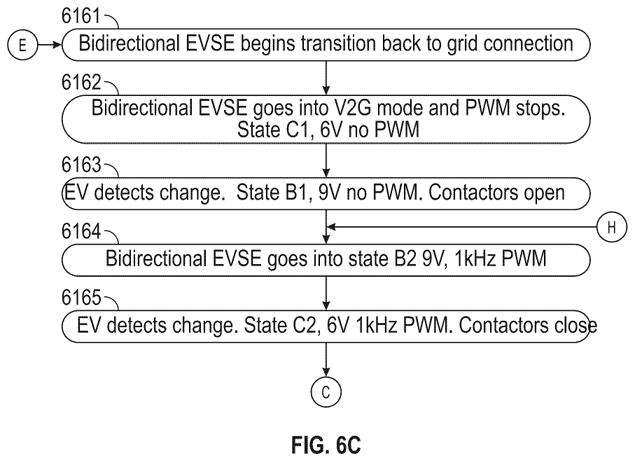

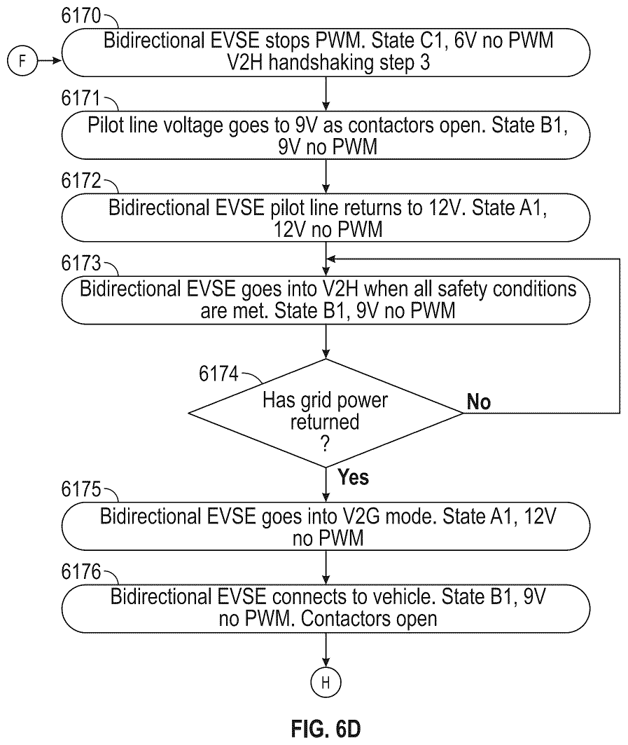

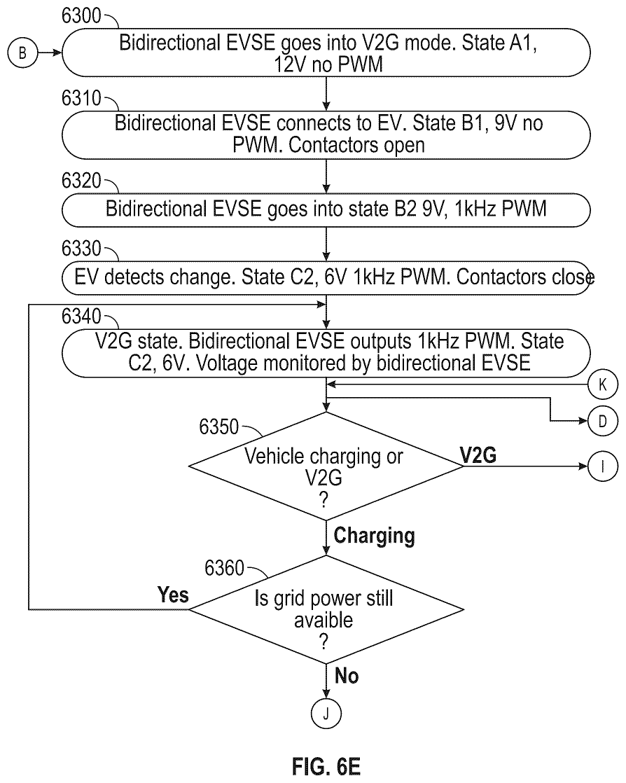

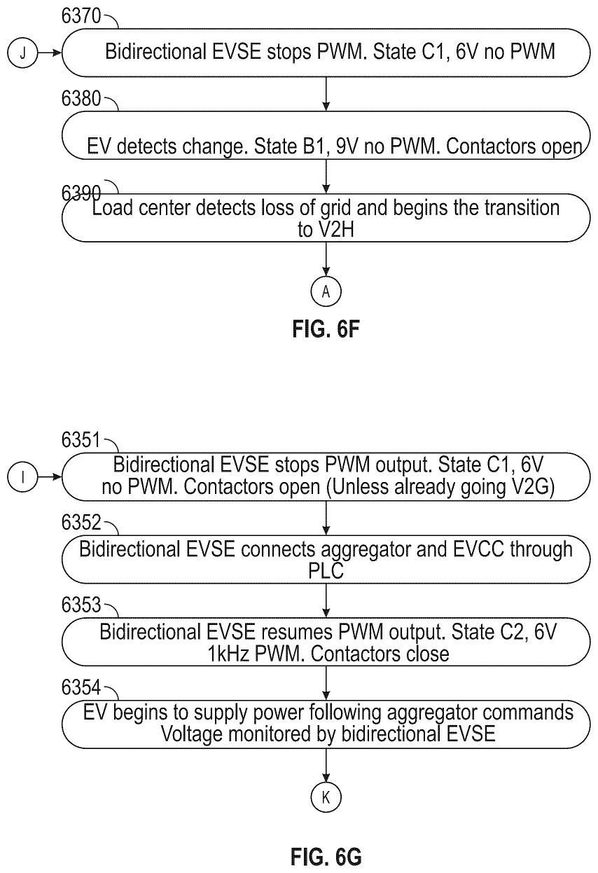

FIGS. 6A-G illustrate a flow chart for a method 6000 of selecting, transitioning and performing an operation mode (e.g., without limitation, V2G and V2H) using the bidirectional EVSE 11 with an on-board smart inverter 22 in accordance with a non-limiting, example embodiment of the disclosed concept. The method 6000 may be performed by the bidirectional EVSE 11, the power distribution system 10 and any components thereof. In the V2H mode, the voltage is monitored by the load center 30. In the V2G mode, the voltage is monitored by the bidirectional EVSE 11. While FIGS. 6A-G illustrate AC V2X technology using an AC on-board smart inverter, similar method applies to DC V2X technology using a DC off-board smart inverter.

At 6010, the bidirectional EVSE determines if an EV is connected to the bidirectional EVSE. If yes, the method 6000 proceeds to 6300. If no, the method 6000 repeats 6100.

At 6020, the bidirectional EVSE determines if the grid power is available. If no, the method 6000 proceeds to 6100 to transition to and perform the V2H mode, and then to the V2G mode. If yes, the method 6000 proceeds to 6300 to transition to the V2G mode.

At 6100, the bidirectional EVSE goes into V2H when all safety conditions are met. The bidirectional EVSE is in the first V2H handshaking state with the first CP voltage (e.g., without limitation, 9V) and no PWM signal.

At 6110, the bidirectional EVSE communications controller begins the first PWM signal (e.g., without limitation, 166 Hz). The bidirectional EVSE is in the second V2H handshaking state with the first CP voltage and the first PWM signal.

At 6120, the EV sees the change of the V2H handshaking state and goes into a third V2H handshaking state with a second CP voltage (e.g., without limitation, 6V) and the first PWM signal. The bidirectional EVSE closes its contactors (i.e., the EVSE smart circuit breaker).

At 6130, the load center detects power. The power distribution system is in the islanded mode.

At 6140, the power distribution system is in the V2H mode. The bidirectional EVSE is in the third V2H handshaking state with the second CP voltage and the first PWM signal. The load center monitors the EV voltage.

At 6150, the bidirectional EVSE determines if the EV is still charged. If yes, the method 6000 proceeds to 6160. If not, the method 6000 proceeds to 6170.

At 6160, the bidirectional EVSE determines if the grid power has returned. If yes, the method 6000 proceeds to 6160. If no, the method 6000 returns to the 6150. At 6161, the bidirectional EVSE begins transition back to the grid connected mode. At 6162, the bidirectional EVSE goes into the V2G mode and the first PWM signal stops. The bidirectional EVSE is in the third V2H handshaking state with the second CP voltage and no PWM signal. At 6163, the EV detects the change in the V2H handshaking state. The bidirectional EVSE goes into the first V2H handshaking state with the first CP voltage and no PWM signal. The bidirectional EVSE opens the EVSE contactors. At 6164, the bidirectional EVSE goes into a second V2G handshaking state with the first CP voltage and a second PWM signal (e.g., without limitation, 1 kHz). At 6165, the EV detects the change of the V2G handshaking state. The bidirectional EVSE enters a third V2G handshaking state with the second CP voltage and the second PWM signals. The bidirectional EVSE closes the EVSE contactors. The method 6000 then returns to 6010.

At 6170, the bidirectional EVSE stops PWM. The bidirectional EVSE is in the fourth V2H handshaking state with the second CP voltage and no PWM signal. At 6171, the bidirectional EVSE opens the EVSE contactors and the CP line voltage goes to the first CP voltage. The bidirectional EVSE enters the first V2H handshaking state with the first CP voltage and no PWM signal. At 6172, the CP pilot line voltage returns to a third CP voltage (e.g., without limitation, 12V). The bidirectional EVSE is in the fifth V2H handshaking state with the third CP voltage and no PWM signal. At 6174, the bidirectional EVSE determines if the grid power has returned. If yes, the method 6000 proceeds to 6175. If not, the method 6000 returns to 6173. At 6175, the bidirectional EVSE goes into the V2G mode and enters the fifth V2G handshaking state with the third CP voltage and now PWM signal. At 6176, the bidirectional EVSE connects to the EV and enters the first V2G handshaking state with the first CP voltage and no PWM signal. The EVSE contactors are open. The method 6000 then proceeds to 6164.

At 6300, the bidirectional EVSE goes into the V2G mode. It is in the fifth V2G handshaking state with the third CP voltage and no PWM signal.

At 6310, the bidirectional EVSE connects to the EV. The bidirectional EVSE enters the first V2G handshaking state with the first CP voltage and no PWM signal. The bidirectional EVSE opens the EVSE contactors.

At 6320, the bidirectional EVSE goes into the second V2G handshaking state with the first CP voltage and the second PWM signal.

At 6330, the EV detects the change in the V2G handshaking state and enters the third V2G handshaking state with the second CP voltage and the second PWM signal. The bidirectional EVSE closes the EVSE contactors.

At 6340, the power distribution system is in the V2G mode. The bidirectional EVSE outputs the second PWM signal. The EV voltage is monitored by the bidirectional EVSE.

At 6350, the bidirectional EVSE determines if the EV is in a charging (V1G) mode or V2G mode or has completed V1G charging. If in the V1G mode, the method 6000 proceeds to 6360. If the EV has completed V1G charging, the method 6000 returns to the 6010. If in the V2G mode, the method 6000 proceeds to 6351. At 6351, unless the EVSE is already in entering the V2G mode, the bidirectional EVSE stops the PWM output and enters the fourth V2G handshaking state with the second CP voltage and no PWM signal. The bidirectional EVSE opens the EVSE contactors. At 6352, bidirectional EVSE connects to the aggregator and the EVCC through wireless connections. At 6353, the bidirectional EVSE resumes the PWM output and enters the third V2G handshaking state with the second CP voltage and the second PWM signal. The bidirectional EVSE closes the EVSE contactors. At 6354, the EV begins to supply power based on a command from the aggregator. The EV voltage is monitored by the bidirectional EVSE.

At 6360, the bidirectional EVSE determines if the grid power is still available. If yes, the method 6000 returns to 6340. If no, the method 6000 proceeds to 6370.

At 6370, the bidirectional EVSE stops the PWM output and enters the fourth V2G handshaking state with the second CP voltage and no PWM signal.

At 6380, the EV detects the change of the V2G handshaking state and the EVSE enters the first V2G handshaking state with the first CP voltage and no PWM signal. The EVSE opens the EVSE contactors.

At 6390, the load center detects the loss of grid and begins the transition to the V2H mode. The method 6000 then returns to 6100.

While specific embodiments of the invention have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of disclosed concept which is to be given the full breadth of the claims appended and any and all equivalents thereof.

What is claimed is:

1. A bidirectional electric vehicle supply equipment (EVSE) for use in a power distribution system including an electric grid, an aggregator, a control panel, an electric vehicle (EV), and loads, the bidirectional EVSE being structured to be coupled to the EV, the aggregator, the control panel, and the loads via the control panel, the bidirectional EVSE comprising:
a voltage sensor structured to sense grid voltage and EV voltage;
an EVSE smart circuit breaker coupled to the voltage sensor and structured to connect or disconnect the EV based on a signal from the voltage sensor and interrupt current flowing to the loads, the EV and/or the electric grid in an event of fault;
an EVSE backup control power structured to provide control power to the bidirectional EVSE when the electric grid is not available or power from the EV is not available; and
a bidirectional EVSE communications controller structured to communicate with the EV, the control panel and the aggregator during selecting an operation mode, transitioning to a selected operation mode, and performing the selected operation mode.

2. The bidirectional EVSE of claim 1, wherein the bidirectional EVSE is coupled to an onboard smart inverter disposed within the EV or an offboard smart inverter disposed outside of the EV and within the bidirectional EVSE.

3. The directional EVSE of claim 2, wherein the bidirectional EVSE supports vehicle-to-everything technology (V2X) including an AC (alternating current) V2X technology associated with the onboard smart inverter and a DC (direct current) V2X technology associated with the offboard smart inverter.

4. The bidirectional EVSE of claim 3, wherein the bidirectional EVSE communication controller is further structured to generate and output a PWM handshaking procedure defined for the operation mode comprising at least a vehicle-to-home (V2H) mode and a vehicle-to-grid (V2G) mode.

5. The bidirectional EVSE of claim 4, wherein the PWM handshaking procedure comprises a PWM handshaking procedure for the V2H mode and a PWM handshaking procedure for the V2G mode, the PWM handshaking procedure for the V2H mode having a first PWM signal and the PWM handshaking procedure for the V2G mode having a second PWM signal.

6. The bidirectional EVSE of claim 4, wherein the bidirectional EVSE is further structured to provide a tripping mechanism by disabling a pulse width modulation (PWM) signal and opening EVSE contactors upon disabling the PWM signal so as to allow the smart inverter to stop operation.

7. The bidirectional EVSE of claim 2, wherein the bidirectional EVSE is structured to provide configurable oversight protections to the onboard or offboard smart inverter, the oversight protections including an overcurrent protection, overvoltage protection, undervoltage protection, over-frequency protection, and under-frequency protection, the adjustable oversight protections comprising adjustable settings for thresholds and tripping times and mechanisms for each operation mode.

8. The bidirectional EVSE of claim 2, wherein the bidirectional EVSE is structured to provide an interlock that prevents the onboard or offboard smart inverter from going into a grid forming mode including a vehicle-to-home (V2H) mode.

9. The bidirectional EVSE of claim 1, wherein the bidirectional EVSE is further structured to support islanding during a loss of the grid voltage.

10. The bidirectional EVSE of claim 2, wherein the bidirectional EVSE is further structured to provide bidirectional voltage awareness such that the bidirectional EVSE prevents the grid from connecting to the loads when the onboard or offboard smart inverter provides EV voltage to the loads in a grid forming mode, and the bidirectional EVSE prevents the onboard or offboard smart inverter from entering the grid forming mode when the grid provides the power to the loads.

11. A power distribution system comprising:
an electric grid;
an electric vehicle (EV);
a plurality of loads;
a control panel connected to the electric grid and including a grid smart circuit breaker structured to connect and disconnect the electric grid from the loads, an EV smart circuit breaker structured to connect and disconnect the EV from the loads and/or the electric grid, and load smart circuit breakers structured to connect and disconnect the loads from the electric grid and/or the EV;
a bidirectional EV supply equipment (EVSE) comprising:
a voltage sensor structured to sense grid voltage and EV voltage;
an EVSE smart circuit breaker coupled to the voltage sensor and structured to connect or disconnect the EV based on a signal from the voltage sensor and interrupt current flowing to the loads, the EV and/or the electric grid in an event of fault;
an EVSE backup control power structured to provide control power to the bidirectional EVSE when the electric grid is not available or power from the EV is not available; and
a bidirectional EVSE communications controller structured to communicate with the EV, the control panel and an aggregator during selecting an operation mode, transitioning to a selected operation mode and performing the selected operation mode; and
the aggregator communicatively coupled to the bidirectional EVSE and structured to monitor and manage the operations of the EV and the bidirectional EVSE.

12. The system of claim 11, further comprising: an onboard smart inverter disposed within the EV or an offboard smart inverter disposed outside of the EV and within the bidirectional EVSE,
wherein the bidirectional EVSE supports vehicle-to-everything technology (V2X) including an AC (alternating current) V2X technology associated with the onboard smart inverter and a DC (direct current) V2X technology associated with the offboard smart inverter.

13. The system of claim 12, wherein the bidirectional EVSE communication controller is further structured to generate and output a PWM handshaking procedure defined for the operation mode comprising at least a vehicle-to-home (V2H) mode and a vehicle-to-grid (V2G) mode, and wherein the PWM handshaking procedure for the V2H mode has a first PWM signal and the PWM handshaking procedure for the V2G mode has a second PWM signal.

14. The system of claim 11, wherein the bidirectional EVSE is structured to provide a tripping mechanism during a protection event by disabling a pulse width modulation (PWM) signal and opening EVSE contactors upon disabling the PWM signal so as to allow the onboard smart inverter or the offboard smart inverter to stop operation.

15. A method of providing power to loads in a power distribution system including an electric grid, an aggregator, a control panel, an electric vehicle (EV) coupled to a smart inverter, and loads, the method comprising:
providing a bidirectional EV supply equipment (EVSE) structured to be coupled to the EV via an EV connector and the loads via the control panel, the bidirectional EVSE comprising (i) a voltage sensor structured to sense grid voltage and EV voltage; (ii) an EVSE smart circuit breaker coupled to the voltage sensor, connect or disconnect the EV based on a signal from the voltage sensor and interrupt current flowing to the loads, the EV and/or the electric grid in an event of fault; (iii) an EVSE backup control power structured to provide control power to the bidirectional EVSE when the electric grid is not available or power from the EV is not available; and (iv) a bidirectional EVSE communications controller structured to communicate with the EV, the control panel and the aggregator during selecting an operation mode, transitioning to a selected operation mode and performing the selected operation mode;
determining that an EV is connected to the bidirectional EVSE;
determining that the electric grid is not available based on the determination that the EV is connected to the bidirectional EVSE;
selecting an operation mode based on the determination that the electric grid is not available;
transitioning to a selected operation mode; and
performing the selected operation mode.

16. The method of claim 15, wherein the bidirectional EVSE supports a vehicle-to-everything (V2X) technology and the operation mode including a vehicle-to-home mode (V2H) and a vehicle-to-grid (V2G) mode.

17. The method of claim 16, further comprising:
performing a pulse width modulation (PWM) handshaking procedure designed for a selected operation mode.

18. The method of claim 17, wherein the PWM handshaking procedure comprises a PWM handshaking procedure for the V2H mode and a PWM handshaking procedure for the V2G mode, the PWM handshaking procedure for the V2H mode having a first PWM signal and the PWM handshaking procedure for the V2G mode having a second PWM signal.

19. The method of claim 15, further comprising:
monitoring EV voltage by the bidirectional EVSE or the control panel.

20. The method of claim 15, further comprising:
providing bidirectional voltage awareness by the voltage sensor disposed in the bidirectional EVSE and structured to sense the grid voltage and EV voltage.
